(19) United States
(12) Patent Application Publication
(10) Pub. No.: US 2026/0065444 A1
(43) Pub. Date: Mar. 5, 2026

(54) DISPLAY DEVICE CAPABLE OF SCREEN DISTORTION CORRECTION AND SCREEN DISTORTION CORRECTION METHOD THEREOF

(71) Applicant: RAONTECH, INC., Seongnam-si, Gyeonggi-do (KR)

(72) Inventors: Min Seok KIM, Seongnam-si, Gyeonggi-do (KR); Ho Kwon KIM, Yongin-si, Gyeonggi-do (KR); Sanghyun PARK, Seongnam-si, Gyeonggi-do (KR); Joon Goo LEE, Seongdong-gu, Seoul (KR); Wook HONG, Chuncheon-si, Gangwon-do (KR)

(73) Assignee: RAONTECH, INC., Seongnam-si, Gyeonggi-do (KR)

(21) Appl. No.: 19/100,879

(22) PCT Filed: Jul. 27, 2023
(86) PCT No.: PCT/KR2023/010904

§ 371 Date: Feb. 3, 2025

(30) Foreign Application Priority Data
Aug. 4, 2022 (KR) 10-2022-0097508

(51) Int. Cl. G06T 5/80; G06F 3/01; G06T 7/73; G09G 3/00

(52) U.S. Cl. CPC G06T 5/80; G06F 3/012; G06T 7/73; G09G 3/001; G09G 2320/0261; G09G 2320/0285; G09G 2320/0673; G09G 2354/00; G09G 2360/18

(57) ABSTRACT

A display device according to the present invention includes: an input part for receiving image data; a record part for processing and recording the image data; a storage part for storing the recorded image data in a frame/line buffer; a reading part for reading out the stored image data; and an output part for outputting the read image data, wherein the reading part includes a backward mapper for generating distortion-reflected image data by using two different LUTs. According to the present invention, it is possible to realize a display device that is very advantageous in terms of processing speed and power consumption by remarkably reducing an amount of calculations required to correct screen distortion. Furthermore, the screen distortion correction is possible only with a very simple configuration and thus it is possible to achieve reduction of size and weight of a wearable device.

### TECHNICAL FIELD

The present invention relates to a display device capable of correcting screen distortion and a method for correcting screen distortion thereof.

### BACKGROUND ART

Recently, in order to implement virtual reality (VR) and augmented reality (AR), small display panels have been made into large virtual screens using optical devices, and technologies are being used to correct screen distortion caused by optical devices. In the case of photographs or videos, to correct optical distortion, the original digital image is pre-calculated as an artificially distorted image using software such as a central processing unit (CPU), graphics processing unit (GPU), or GPGPU (general purpose computing on the GPU), and then stored in a buffer, etc. Afterwards, a technology is used to alleviate distortion by transmitting it to a display device and playing it back. Alternatively, when saving an image as a file, a technology is used to convert it into a distorted image by considering a specific optical device, save it, and then transmit the converted image to a display panel and play it back. Since this image conversion process requires complex calculations and frequent video memory access, real-time processing is difficult, so a separate software content creation tool is mainly used to create image information to be transmitted to the display device in advance. In order to correct this in real time, it is inevitable to use parallel processing of the desktop-level central processing unit and graphic processing unit, as in the case of the Oculus Rift. Since the image data transmitted to the display device is already distorted, there may be a problem of recognizing it as an abnormal screen when displaying it on a general display device. In order to correct this on the display device, it is necessary to go through a process that is almost identical to the process of distorting the image data. Therefore, if a software method is used like the existing method, a powerful CPU, GPU, or GPGPU is required, which inevitably increases cost and power consumption.

Unlike the panels used in general monitors, display panels used in HMDs (Head Mounted Displays), HUDs (Head Up Displays), or Pico-Projectors enlarge and project a small display screen using optics, so various distortions may occur when the user views the final screen. In particular, failure-shaped or cylindrical distortion that occurs when high-magnification optical devices are used to make a small screen into a large virtual screen may affect the image quality by bending the edges of the input image, which may be a distraction when the user enjoys the image information. In addition, perspective distortion and aberration distortion may appear in a complex manner depending on the design of the optical device.

Perspective distortion occurs when the screen's top, bottom, left, and right ratios are not right, resulting in a distorted screen (Keystone) that is not rectangular. High-power lenses may also cause chromatic aberration, which distorts the colors they are trying to express, due to the difference in refractive index depending on the wavelength of light. Since this distortion is an inevitable phenomenon that occurs only to a certain degree when using optics, it may not be completely eliminated, so the goal is to make it unrecognizable to humans. To this end, expensive lenses that combine convex and concave lenses are generally used to change the design of the optical device, or methods are generally used to correct and improve it through digital image processing.

The technology for correcting image distortion caused by optics is mainly used to improve the image quality of displays that convert images taken by a camera and already stored in a distorted state into digital images and correct them post-hoc using software algorithms, such as graphic processors or digital signal processing devices such as DSPs (Digital Signal Processors), or to display images on curved screens using cathode rays. Recently, it has been used to correct distortion in the results taken by digital cameras through image processing and store them in storage devices. In general, flat-panel displays such as LCDs and OLEDs that directly express pixels are mainly used, and optical devices are not required except for applications such as projectors. Recently, limited image distortion correction technologies are being used as small display panels are made into large virtual screens using optical devices to implement virtual reality and augmented reality.

Optical distortion has nonlinear characteristics because it is a combination of distortion caused by lenses, perspective distortion caused by the panel where pixels are expressed, and the space where the screen is displayed. When correcting using digital image processing, there is a characteristic of a large amount of computation. In addition, as the image resolution to be processed increases, real-time processing becomes difficult due to limitations in memory bandwidth and response speed, and increased computation.

Various correction techniques have been used, including lens distortion-induced failure/cylindrical correction, and keystone correction. However, the correction technology up to now has not been able to solve this problem in real time on the display device, but has been used to manipulate the image source in advance before transmitting the image information to the display device. The already manipulated image is transmitted to the display device, and then a method is used to correct the distorted screen afterwards using optical methods.

In order to use the technology that alleviates various types of distortion caused by optics or the technology that reconverts image data that has already been distorted and transmitted to a display device to suit the environment of the user viewing the display device, a low-power, low-cost correction technology is needed even in small mobile devices. However, there are difficulties in solving this problem using conventional methods.

On the other hand, unlike simple HMD systems, AR applications tend to require quite sophisticated systems. These include powerful APs (Application Processors) along with GPUs (Graphics Processing Units) and memory systems, wireless communication systems, small monocular or binocular display systems with optical systems, multiple cameras and IMUs (Inertial Measurement Units) for visual SLAM (Simultaneous Localization and Mapping), and user interfaces. These complex systems ultimately result in larger and heavier systems due to their power consumption, and shorter usage times. Users expect simple displays for AR applications, but few products satisfy this need.

Objects rendered in 3D are augmented into the real world, giving users the ability to interact naturally while considering their surroundings. Although there has been significant progress in realizing such devices in recent years, the system size is still considerable. Therefore, the final product takes the form of goggles rather than glasses, and has the problem of limited usage time and high cost due to high computing performance.

The head-mounted device includes a display, sensing, and high-speed wired interface to minimize size and weight. Then, it is connected to a dedicated computing box or a computing device such as a conventional smartphone for all processing required for AR applications. The computing device includes a rechargeable battery and supplies power to the head-mounted device. However, the user still feels uncomfortable due to the wiring.

Smart glasses, including video glasses, are often perceived as AR glasses despite their lack of features such as SLAM. They are optimized for power consumption and size, and use relatively low-power processors to display multimedia. Typically, display systems display a screen floating in front of the user's eyes or turn off the display until needed. The augmented view does not interact with the real world, and therefore often unintentionally blocks the user's view.

Standalone or tethered lightweight wearable multimedia viewers are attractive to users in a variety of fields. However, currently available glass-type devices have the problem of being limited in resources and power budgets, making it difficult to provide rich features.

### PRIOR ART DOCUMENT

### Patent Document

(Patent Document 1) Korean Patent Registration No. 10-1785027 (Registered on Sep. 28, 2017)

### DISCLOSURE

### Technical Problem

The present invention provides a display device capable of correcting screen distortion in a very simple manner and a screen distortion correction method thereof. The present invention also provides a display device without distraction by using an inexpensive and simple solution.

### Technical Solution

An embodiment of the present invention provides a display device including: an input unit for receiving image data; a recording unit for processing and recording the image data; a storage unit for storing the recorded image data in a frame/line buffer; a reading unit for reading the stored image data; and an output unit for outputting the read image data, in which the reading unit includes a backward mapper that generates distorted reflection image data using two different LUTs.

In an embodiment, the above two LUTs may include an X-axis LUT (Look-Up Table) for X-axis interpolation and a Y-axis LUT for Y-axis interpolation.

In an embodiment, the backward mapper may include a backward LUT generation unit for generating the X-axis LUT and the Y-axis LUT; a data pipeline for processing image data input from the frame/line buffer; and a backward mapper FSM for generating position information of each pixel based on the X-axis LUT and the Y-axis LUT and controlling the data pipeline.

In an embodiment, the data pipeline may include a Y-axis interpolation unit performing the Y-axis interpolation based on position information of pixels generated from the backward mapper FSM and the Y-axis LUT; and an X-axis interpolation unit performing the X-axis interpolation based on position information of pixels generated from the backward mapper FSM and the X-axis LUT.

In an embodiment, the data pipeline may further include a Y-axis interpolation buffer storing blocks required for the Y-axis interpolation calculation; an X-axis interpolation buffer storing blocks required for the X-axis interpolation calculation; a depacketizer extracting only pixel information required for the Y-axis and X-axis interpolation calculations from image data stored in block units; and one or more gamma converters converting the extracted pixel information into a gamma curve of a final display.

In an embodiment, the backward LUT generation unit may generate different X-axis LUTs and Y-axis LUTs depending on the type of image distortion.

In an embodiment, when the image distortion is keystone distortion or rotation distortion, the backward LUT generation unit may generate each of the Y-axis LUT and the X-axis LUT based on at least one of a yaw value, a pitch value, a roll value, a rotation axis, and a field of view (FOV) according to user's movement.

In an embodiment, when the image distortion is a scaler or shift distortion, the backward LUT generation unit may generate each of the Y-axis LUT and the X-axis LUT based on at least one of an X-value change amount, a Y-value change amount, and a Z-value change amount transmitted according to the user's movement.

In an embodiment of the present invention, a method for correcting screen distortion includes: generating an X-axis LUT (Look-Up Table) and a Y-axis LUT for generating a distorted reflection image; generating position information of each pixel based on the X-axis LUT and the Y-axis LUT; performing Y-axis interpolation using the position information of the pixel and the Y-axis LUT for data read from a frame/line buffer; performing X-axis interpolation using the position information of the pixel and the X-axis LUT for data read from the frame/line buffer; and outputting a distorted reflection image in which the Y-axis interpolation and the X-axis interpolation are performed.

In an embodiment, the method may further include depacketizing to extract only pixel information required for Y-axis interpolation and X-axis interpolation from data stored in block units.

In an embodiment, the method may further include a converting the extracted pixel information into a gamma curve of a final display.

In an embodiment, the generating step may generate the Y-axis LUT and the X-axis LUT respectively based on at least one of the yaw value, pitch value, roll value, rotation axis and field of view (FOV) according to the user's movement when the image distortion is keystone distortion or rotation distortion.

In an embodiment, the generating of the X-axis LUT and the Y-axis LUT may generate each of the Y-axis LUT and the X-axis LUT based on at least one of an X value change amount, a Y value change amount, and a Z value change amount according to the user's movement, when the image distortion is scaler or shift distortion.

### Advantageous Effects

According to the present invention, the amount of calculation required for screen distortion correction may be drastically reduced, thereby implementing the display device that is very advantageous in terms of processing speed and power consumption. In addition, since screen distortion correction is possible with only a very simple configuration, it is possible to promote miniaturization and weight reduction of wearable devices.

Also, according to the present invention, the virtual screen view reflects the user's intentions through head movement tracking. Thus, by displaying multimedia content only when the user's gaze is within the target area, the user may feel as if vision thereof is fixed in the space and move head thereof to see the surrounding contents with great clarity.

Also, according to the present invention, by turning off the entire display system and/or associated modules when the user's gaze leaves the target area, energy consumption may be saved without blocking the real world (i.e., without distraction).

Also, according to the present invention, the view may be freely zoomed in and out, and lens distortion and chromatic aberration caused by the optical system used in the HMD may be alleviated while using dynamic view morphing.

### DESCRIPTION OF DRAWINGS

FIG. 1 is a detailed view showing an overall architecture of a display according to the present invention.

FIG. 2 is a block diagram of a reading unit including a backward mapper.

FIG. 3 is a block diagram showing a detailed configuration of a display control unit.

FIG. 4 is a conceptual view explaining the operation of the input unit of the display control unit.

FIG. 5 is a conceptual view for explaining an operation of a recording unit of the display control unit.

FIG. 6 is a conceptual view for explaining an operation of a storage unit and frame/line buffer of the display control unit.

FIG. 7 is a conceptual view for explaining an operation of the reading unit of the display control unit.

FIG. 8 is a conceptual view for explaining an operation of an output of the display control unit.

FIGS. 9a to 9c are views illustrating various display distortions.

FIGS. 9a to 9c are views illustrating various display distortions.

FIG. 11 is a conceptual view for explaining basic principles of backward mapping.

FIG. 12 is a view illustrating an example of a backward mapping grid.

FIG. 13 is a block diagram of a backward mapper provided in a display according to the present invention.

FIG. 14 is a view illustrating how the data pipeline calculates pixels.

FIG. 15 is a view illustrating a result image according to gamma conversion.

FIG. 16 is a view for explaining a two-step interpolation process in a data pipeline.

FIG. 17 is a schematic view showing a method for generating X-axis and Y-axis

LUTs.

FIG. 18 is a block diagram of a system using a backward mapper according to the present invention.

FIG. 19 is a view illustrating the types of image processing to be performed in response to Yaw, Pitch, Roll, X, Y, and Z movements according to a user's head motion in the system illustrated in FIG. 18.

FIG. 20 is a view for explaining an effect of the display according to the present invention.

FIGS. 21a and 21b are views showing application examples of the present invention.

FIG. 22 is a view showing another application example of the present invention.

### MODE FOR INVENTION

Hereinafter, embodiments disclosed in the present specification will be described in detail with reference to the attached drawings. However, identical or similar components will be assigned the same reference numbers regardless of reference numerals, and duplicate descriptions thereof will be omitted. The suffix “part” for the components used in the following description is given or used interchangeably only for the ease of preparing the specification, and does not have a distinct meaning or role in itself.

Also, in describing the embodiments disclosed in this specification, if it is determined that detailed descriptions of related known technologies may obscure the gist of the embodiments disclosed in this specification, the detailed descriptions will be omitted. In addition, the attached drawings are only intended to facilitate understanding of the embodiments disclosed in this specification, and the technical idea disclosed in this specification is not limited by the attached drawings. This specification should be understood to include all changes, equivalents, and substitutes included in the spirit and technical scope of the present invention.

Hereinafter, embodiments according to the present invention will be described in detail with reference to the attached drawings.

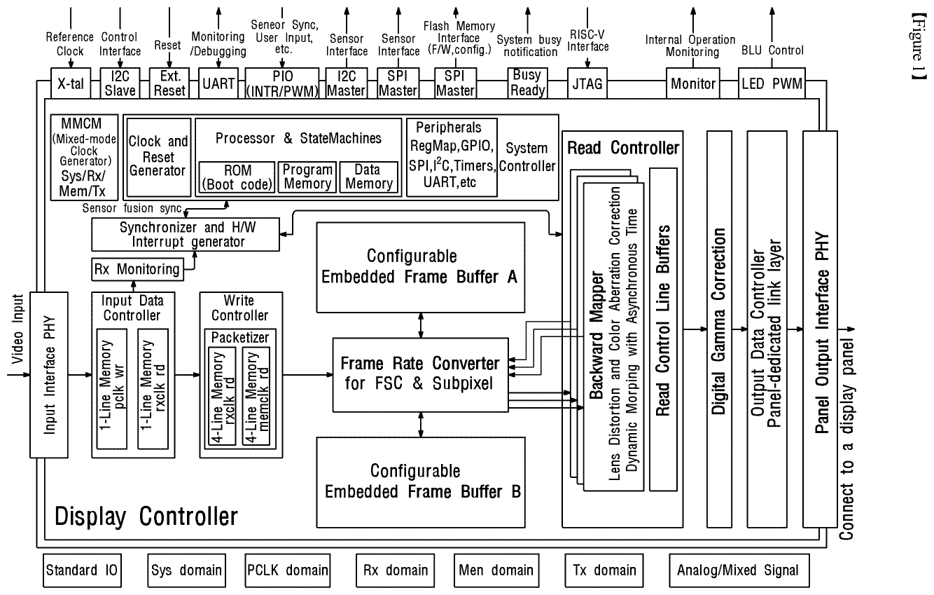

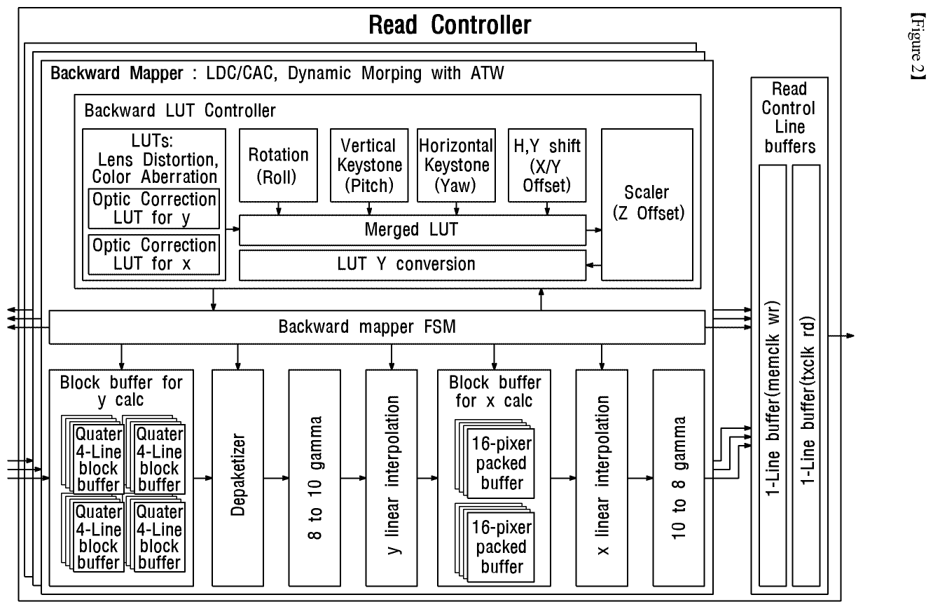

FIG. 1 is a detailed view showing an overall architecture of a display according to the present invention. FIG. 2 is a block diagram of a reading unit including a backward mapper.

With respect to the architecture illustrated in FIG. 1, a description of a configuration that is not directly related to the present invention will be omitted. Considering the display controller, the display according to the present invention may be divided into following four main parts.
\textcircled{1} Input video processing part: High-speed video interface PHY (physical layer)
\textcircled{2} Frame buffer control part: Frame buffer recording unit, frame rate converter with color separation processing function, and frame buffer reading unit
\textcircled{3} Display panel interface part: Additional image processors, output pixel data formatter (link layer), and high-speed panel interface PHY
\textcircled{4} System control part: Clock generators such as PLLs (Phase Lock Loops), clock dividers, reset control logic, processors and various peripherals, state machines, etc.

As illustrated in FIG. 2, the display according to the present invention includes a reading unit having a backward mapper. The backward mapper may correct chromatic aberration by processing each primary color field by integrating a total of three mappers. In the case of an FSC type display, only one backward mapper may be activated to reduce power consumption. In the case of a conventional sub-pixelated display, it is also possible to use three mappers simultaneously.

The Backward LUT Controller has a function of generating LUT values for each grid. Although a fixed size may be used for each grid, the embodiment of the present invention is not limited thereto. Using a fixed size grid has an advantage of facilitating backward address calculation without a divider, allowing only an adder and a shifter to be used for backward address calculation, and making it easy to support various display resolutions. Lens distortion and chromatic aberration information are stored in a LUT (Look Up Table). Grid-based bi-linear approximation may be applied to compensate for distortion caused by the optical system using the LUT. The LUT is generated according to the estimated Euler angle (Roll, Pitch, Yaw) of the head motion, and the frame image stored in the frame buffer is dynamically morphed on the fly. The IPD (Inter Pupillary Distance), the position offset of the two eyes on the rotation axis, the target distance of the visual signal from the eye to match the display view, the VFOV/HFOV of the given optics and input video, and the output display resolution are required for LUT generation to properly track the given visual signal. Position tracking information may be used with Euler angles, but it is difficult to achieve accurate position tracking with only low-cost IMUs, so it may be implemented as an optional feature. Position tracking information may be provided for more accurate view changes to implement a fully-functional AR system with the help of an external vision system. A LUT generator for the scaler may be used to scale up and down content with a simple user interface.

The backward mapper FSM (Finite State Machine) has the function of controlling the timing of LUT generation, LUT data reading, frame buffer request and reading, pixel data packet release, and pixel data interpolation. The backward mapper FSM requests the required pixel data based on the Y-axis relative pixel position converted from the final LUT value along with a synchronization signal for smooth streaming.

Block buffer and interpolator with gamma conversion function generates line-by-line transformed image without damaging gamma. Pixel data requested by backward mapper FSM is transmitted from frame rate converter and then buffered in block buffer for Y-axis pixel calculation. Although 16-chunk buffer may be used to maximize spatial and temporal locality, the embodiment of the present invention is not limited thereto. Each buffer stores a group of pixel data from a different area of frame image for the calculated LUT value. One word of frame buffer memory may contain multiple pixel data. Packetizer reorganizes pixels into tiles for interpolation process. Depacketizer extracts pixel data required for Y-axis interpolation in time and applies 8 to 10-bit gamma conversion to maintain brightness, and then linearly interpolates pixels. Vertically interpolated pixels are buffered in 1-line buffer cache for X-axis calculation, and then interpolate pixels for X-axis in cache. After the morphing view is generated, a 10 to 8 bit degamma adjusts the bit depth for the rest of the digital image processing. Finally, a new color field image for FSC type displays or a new frame image for sub-pixelated displays is directed to the line buffer of the read control line buffer line by line.

Meanwhile, the embedded processor of the display controller is responsible for flexible compute-intensive tasks such as Euler angle calculation from the interface IMU sensor. It is also responsible for proper control of the hardware IP blocks with synchronized timing. Every sensor vendor provides different specifications and communication protocols for reading sensor data, so the processor must provide flexibility. The firmware runs on the processor to handle the sensor fusion algorithm for motion tracking and ATW operation using the designed hardware. I2C (Inter-integrated Circuit) or SPI (Serial Peripheral Interface) is a common interface for IMU sensors, and most sensors provide a synchronization signal for sensor data output as an interrupt. The system controller utilizes these interfaces to support various sensors.

The overall architecture and overall function of the display according to the present invention have been described above. Hereinafter, a detailed description will be given of the operation of each component directly related to the present invention.

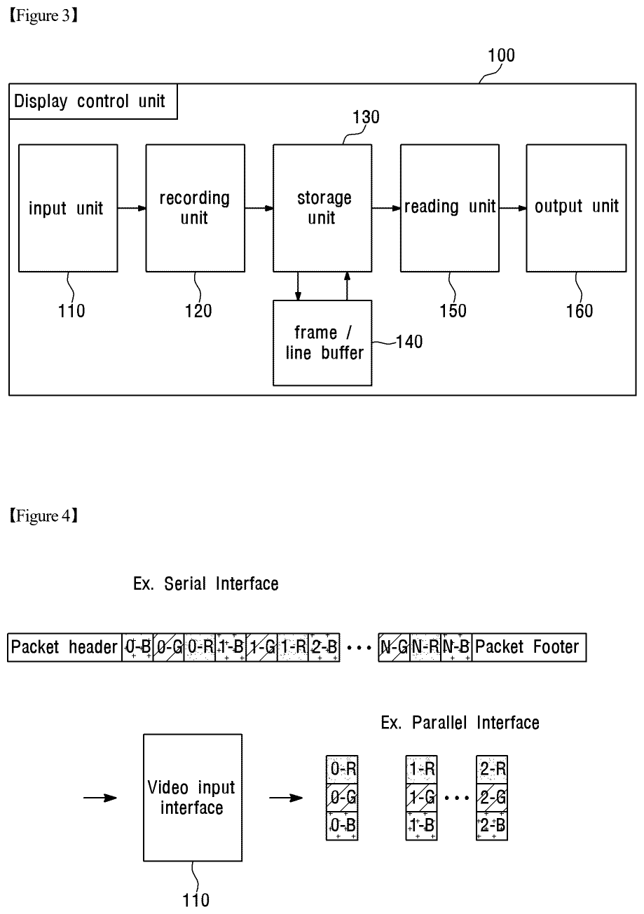

FIG. 3 is a block diagram showing a detailed configuration of a display control unit. The display control unit has a function of converting a video format suitable for a panel, converting from sub-pixel video data to field sequential video data, performing frame rate conversion, or performing image processing. A designed display control unit 100 may be simplified into a form as shown in FIG. 3, and arrows in FIG. 3 indicate a flow of video (image) data.

Specifically, the display control unit 100 includes an input unit 110, a recording unit 120, a storage unit 130, a reading unit 150, and an output unit 160. The input unit 110 receives image data. The image may include a still image and a moving image. The recording unit 120 processes and records the image data. The storage unit 130 stores the image data transmitted from the recording unit 120 in a frame/line buffer 140. The reading unit 150 reads the image data stored by the storage unit 130, and the output unit 160 outputs the read image data.

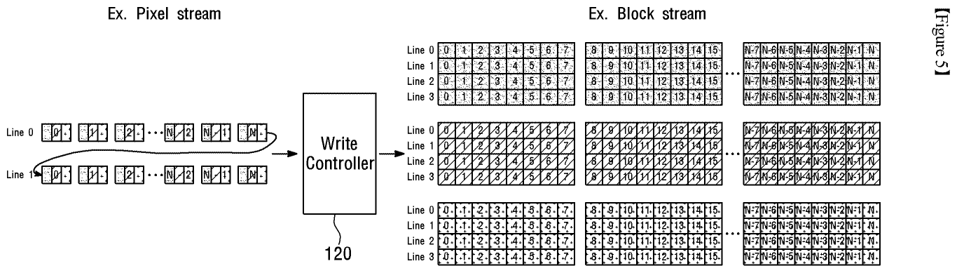

FIG. 4 is a conceptual view explaining the operation of the input unit of the display control unit.

As shown in FIG. 4, the input unit of the display control unit receives a high-speed video interface (MIPI DSI or Open LDI) input from an external video source (AP, GPU, etc.) and converts it into a 24-bit RGB parallel interface.

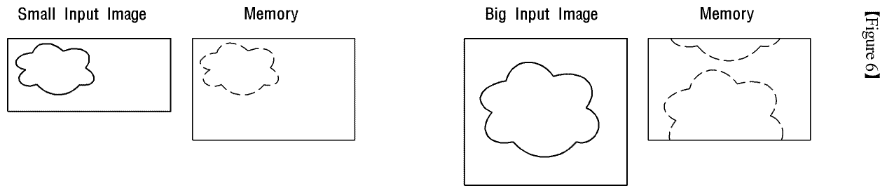

FIG. 5 is a conceptual view explaining the operation of the recording unit of the display control unit. The method of specifying an address for each pixel and storing it in memory is inefficient, so the recording unit 120 separates data by color without performing different image processing for each color, so as to be advantageous for driving a field-sequential color display. In addition, in order to increase the memory bus width, the video image is divided into blocks of a certain size (1×16, 4×4, 8×4, etc.). The recording unit 120 transfers the data collected by block to the storage unit 130.

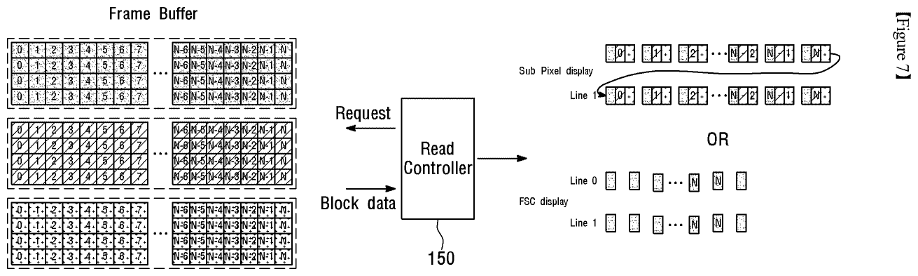

FIG. 6 is a conceptual view for explaining an operation of the storage unit and frame/line buffer of the display control unit.

The storage unit 130 stores data transmitted from the recording unit 120 and transmits the stored data when requested by the reading unit 150 that will be described later. Here, the priority is on the recording of data. Since the memory size is fixed, when an image larger than the memory is input, the data that came in first may be overwritten.

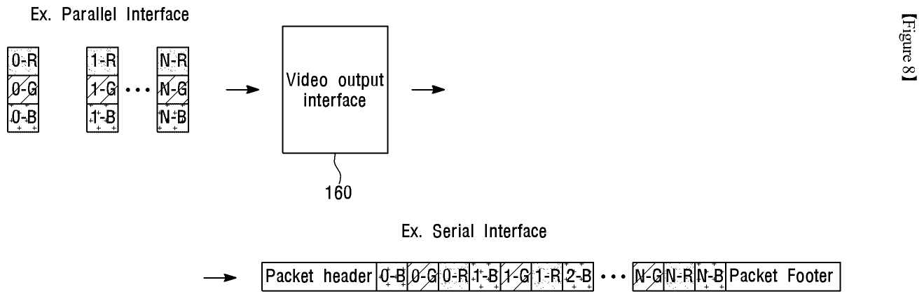

FIG. 7 is a conceptual view for explaining an operation of the reading unit of the display control unit.

The reading unit 150 requests block data required for the video stream from the frame/line buffer 140. The reading unit 150 separates pixel data that matches the video timing from the block data received from the frame/line buffer 140 and outputs the separated pixel data. Also, the reading unit 150 converts the data into a data format suitable for the display type (FSC, sub-pixel).

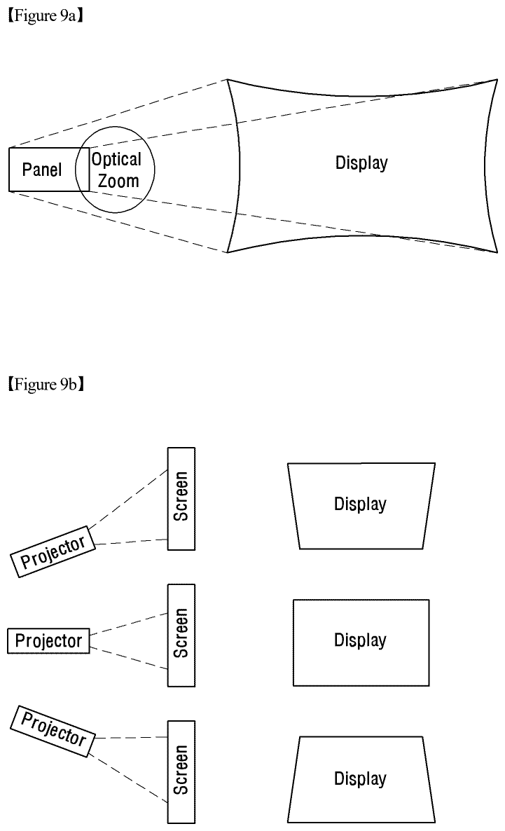

FIG. 8 is a conceptual view for explaining an operation of an output of the display control unit.

The output unit 160 converts pixel-based parallel data into a video interface format (MIPI DSI or Open LDI) suitable for the panel.

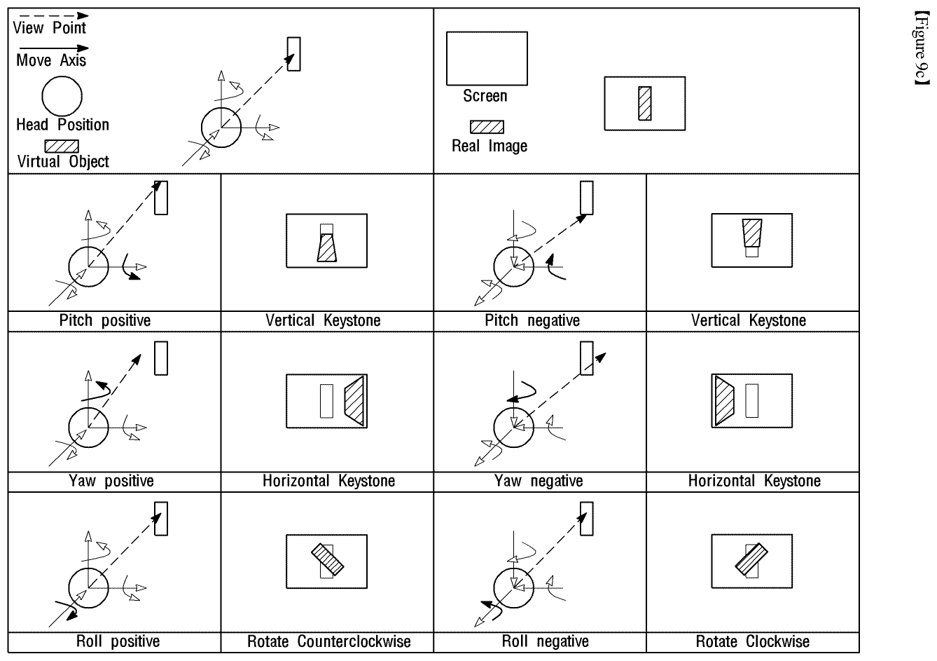

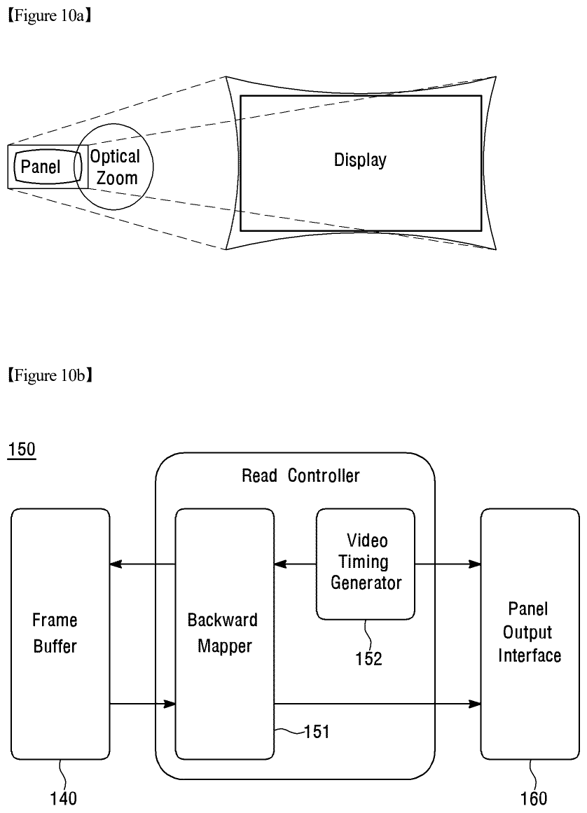

FIGS. 9a to 9c are views illustrating various display distortions. Specifically, FIG. 9a shows distortion due to structure (optical distortion), FIG. 9b shows distortion due to usage environment (keystone distortion), and FIG. 9c shows distortion due to usage method. In particular, FIG. 9c shows distortion caused by movement of an object due to movement of a user's gaze in a wearable device worn by a user.

As illustrated in FIGS. 9a to 9c, various image distortions may occur depending on the structure, usage environment, and usage method of the display device or a wearable device (e.g., HMD) including the display device. According to the present invention, such distortions may be corrected in a simple manner.

FIGS. 10a and 10b are views showing examples of display distortion correction according to the present invention and a configuration therefor.

As illustrated in FIG. 10a, the display according to the present invention corrects distortion by transmitting and displaying a pre-distorted image that reflects distortion in advance on the panel to correct distortion. The reading unit for creating such a distorted image includes a backward mapper.

To this end, the display according to the present invention includes a backward mapper 151 in the reading unit 150. A detailed configuration and operation of the backward mapper 151 will be described in detail below.

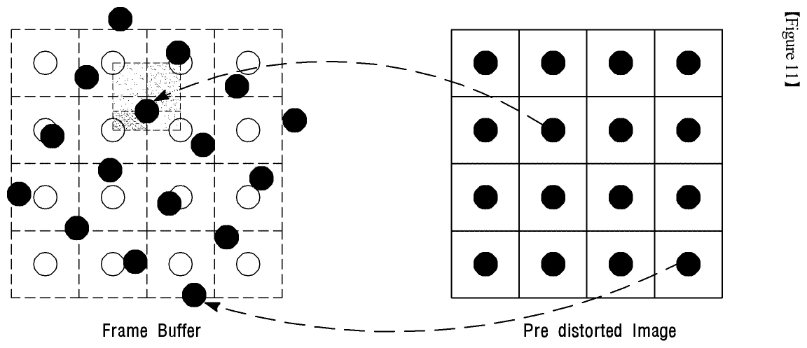

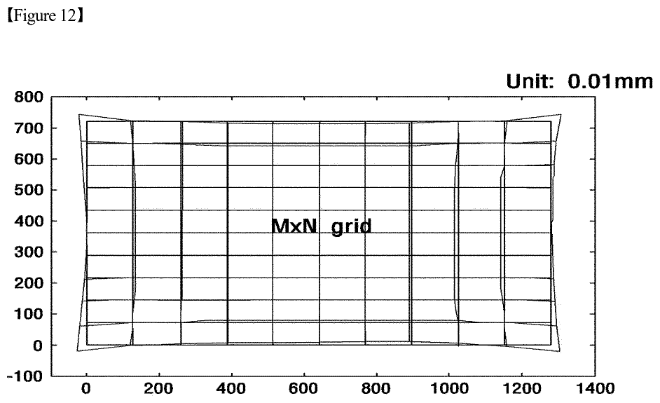

FIG. 11 is a conceptual view explaining a basic principle of backward mapping, and FIG. 12 shows an example of a backward mapping grid. The backward mapping is a method of processing a desired image (distorted image) by referencing an existing image (image in a frame/line buffer). The pixel to be created has location information of the image to be referenced. Then, based on the location information, four adjacent pixel data are interpolated to generate a new pixel value.

Here, there is a problem in that calculating the position information of all pixels increases the amount of computation, and storing the position information of all pixels requires a lot of memory. However, since the distortion is continuous, it may be inferred through surrounding information. As shown in FIG. 12, the screen is divided into certain areas, position information corresponding to each corner is stored or calculated, and then the values stored for each area are interpolated to obtain reference position information for all pixels.

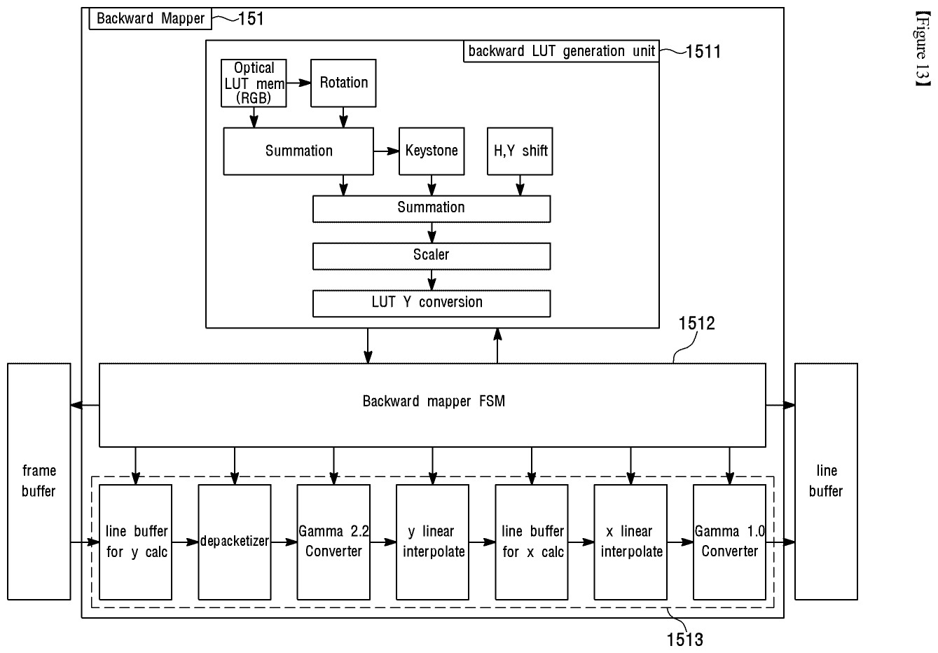

FIG. 13 is a block diagram of a backward mapper disposed in the display according to the present invention. The backward mapper 151 disposed in the reading unit 150 includes a backward LUT generation unit 1511, a backward mapper FSM 1512, and a data pipeline 1513. The backward LUT generation unit 1511 has a function of generating an LUT (Look Up Table) required for backward mapping. More specifically, the backward LUT generation unit 1511 generates the X-axis LUT and the Y-axis LUT. The backward mapper FSM 1512 generates position information of each pixel based on the LUT. More specifically, the backward mapper FSM 1512 generates position information of each pixel based on the X-axis LUT and the Y-axis LUT and controls the data pipeline 1513. Finally, the data pipeline 1513 has a function of processing data transmitted from a frame buffer.

Since image distortion appears in combinations of various forms, correction values suitable for each form are combined and used. When a LUT is generated externally, the LUT may not be suitable for using a video stream because it takes time to generate and transmit. However, in some cases, it is possible to generate a LUT externally. The backward LUT generation unit 1511 may generate different X-axis LUTs and Y-axis LUTs depending on the form of image distortion. In the case of optical distortion, it is not easy to formulate a formula and it is not a value that changes during use, so the Optical LUT may be stored in the memory and used. Here, the chromatic aberration caused by the optics may be reduced by using different correction values for each RGB. In the case of keystone distortion or rotation distortion, the backward LUT generation unit may generate the Y-axis LUT and the X-axis LUT based on at least one of a yaw value, a pitch value, a roll value, and some parameters (rotation axis and field of view (FOV)) according to the user's movement.

Also, when the image distortion is a scaler or shift distortion, the backward LUT generation unit may generate each of the Y-axis LUT and the X-axis LUT based on at least one of an X-value change amount, a Y-value change amount, and a Z-value change amount transmitted according to the user's movement.

What is important here is that the LUT expressed as (x,y), which is the position of the pixel to be referenced, includes an X-axis LUT and a Y-axis LUT. Therefore, it should be converted to (0,y′), (x′,0) to interpolate separately into the X-axis and Y-axis.

The position of a pixel is expressed as a relative distance based on the intersection of the X-axis and the Y-axis. The X-axis and the Y-axis may vary depending on the type or system of the optical system based on the display screen. The value of the LUT generated by the formula corresponds to the relative distance and relative coordinates based on the pixel.

In the case of image shift where the image position moves up, down, left, and right, the X-axis LUT and Y-axis LUT may be set as follows. However, the embodiment of the present invention is not limited thereto.

$$X - axis LUT : {x}^{′} - x = ( x - shift\_x ) - x = - shift\_x$$

$$Y - axis LUT : {y}^{′} - y = ( y - shift\_y ) - y = - shift\_y$$

(x, y: pixel position, x′, y′: reference position, shift_x, shift_y: move position)

For image scale where the image size is enlarged or reduced, the X-axis LUT and Y-axis LUT may be set as follows. However, the embodiment of the present invention is not limited thereto.

$$X - axis LUT : {x}^{′} - x = x / intp\_x - x$$

$$Y - axis LUT : {y}^{′} - y = y / intp\_y - y$$

(x, y: pixel position, x′, y′: reference position, intp_x, intp_y: interpolation ratio)

For image rotate where the image rotates clockwise or counterclockwise, the X-axis LUT and Y-axis LUT may be set as follows. However, the embodiment of the present invention is not limited thereto.

$$X - axis LUT : {x}^{′} - x = r * cos ( a - b ) - x = r * cos ( a ) * cos ( b ) + r * sin ( a ) * sin ( b ) - x = x * cos ( b ) + y * sin ( b ) - x = x * ( cos ( b ) - 1 ) + y * sin ( b )$$

$$Y - axis LUT : {y}^{′} - y = r * sin ( a - b ) - y = r * sin ( a ) * cos ( b ) - r * cos ( a ) * sin ( b ) - y = y * cos ( b ) - x * sin ( b ) - y = y * ( cos ( b ) - 1 ) - x * sin ( b )$$

(x, y: pixel position, x′, y′: reference position, r: radius of pixel position, a: pixel position angle, b: rotation angle)

For vertical keystone, the X-axis LUT and Y-axis LUT may be set as follows, but are not limited thereto.

$$X - axis LUT : {x}^{′} / x = {y}^{′} / y$$

$${x}^{′} = dx / ( d - tan ( a ) * y )$$

$${x}^{′} - x = sin ( a ) * y * x / ( cos ( a ) * d - sin ( a ) * y )$$

Y-axis LUT: y′ is the cross point of the virtual panel and the view point

$$tan ( a ) * {y}^{′} = d / y * {y}^{′} - d$$

$${y}^{′} = dy / ( d - tan ( a ) * y )$$

$${y}^{′} - y = sin ( a ) * y \hat{} 2 / ( cos ( a ) * d - sin ( a ) * y$$

(x, y: pixel position, x′, y′: reference position, d: view point distance, a: rotation angle)

According to Keystone Formula 1, the X-axis LUT and Y-axis LUT may be set as follows. However, the embodiment of the present invention is not limited thereto.

X-axis LUT: x′ is the intersection of the virtual panel and the viewpoint

$$tan ( a ) * {x}^{′} = d / x * {x}^{′} - d$$

$${x}^{′} = dx / ( d - tan ( a ) * x )$$

$${x}^{′} - x = sin ( a ) * x \hat{} 2 / ( cos ( a ) * d - sin ( a ) * x )$$

$$Y - axis LUT : {y}^{′} / y = {x}^{′} / x$$

$${y}^{′} = dy / ( d - tan ( a ) * x )$$

$${y}^{′} - y = sin ( a ) * x * y / ( cos ( a ) * d - sin ( a ) * x )$$

(x, y: pixel position, x′, y′: reference position, d: viewpoint distance, a: rotation angle)

According to Keystone Formula 2-1, the X-axis LUT and Y-axis LUT may be set as follows. However, the embodiment of the present invention is not limited thereto. This corresponds to a LUT for compensating for keystone caused by the tilt of the screen.

$$X - axis LUT : {x}^{′} - x = x * d * cos ( va ) * cos ( ha ) / ( d * cos ( va ) * cos ( ha ) - sin ( ha ) * x - sin ( va ) * cos ( ha ) * ( y ) - x$$

$$Y - axis LUT : {y}^{′} - y = y * d * cos ( va ) * cos ( ha ) / ( d * cos ( va ) * cos ( ha ) - sin ( ha ) * x - sin ( va ) * cos ( ha ) * ( y ) - y$$

(x, y: pixel position, x′, y′: reference position, d: viewpoint distance, va: vertical rotation angle, ha: horizontal rotation angle)

By Keystone Formula 2-2, the X-axis LUT and Y-axis LUT may be set as follows. However, the embodiment of the present invention is not limited thereto. This corresponds to a LUT for compensating for keystone that occurs when a projector moves on a fixed screen.

$$X - axis LUT : {x}^{′} - x = x * d * cos ( va ) / ( d * cos ( va ) * cos ( ha ) - sin ( ha ) * x - sin ( va ) * cos ( ha ) * y ) - x$$

$$Y - axis LUT : {y}^{′} - y = ( y * d * cos ( ha ) + x * dist * sin ( va ) * sin ( ha ) ) \text{} / ( d * cos ( va ) * cos ( ha ) - sin ( ha ) * x - sin ( va ) * cos ( ha ) * y ) - y$$

(x, y: pixel position, x′, y′: reference position, d: viewpoint distance, va: vertical rotation angle, ha: horizontal rotation angle)

The data pipeline 1513 may include a buffer for Y-axis interpolation, a depacketizer, a gamma 2.2 conversion unit, a Y-axis interpolation unit, a buffer for X-axis interpolation, an X-axis interpolation unit, and a gamma 1.0 conversion unit. However, the embodiment of the present invention is not limited to thereto.

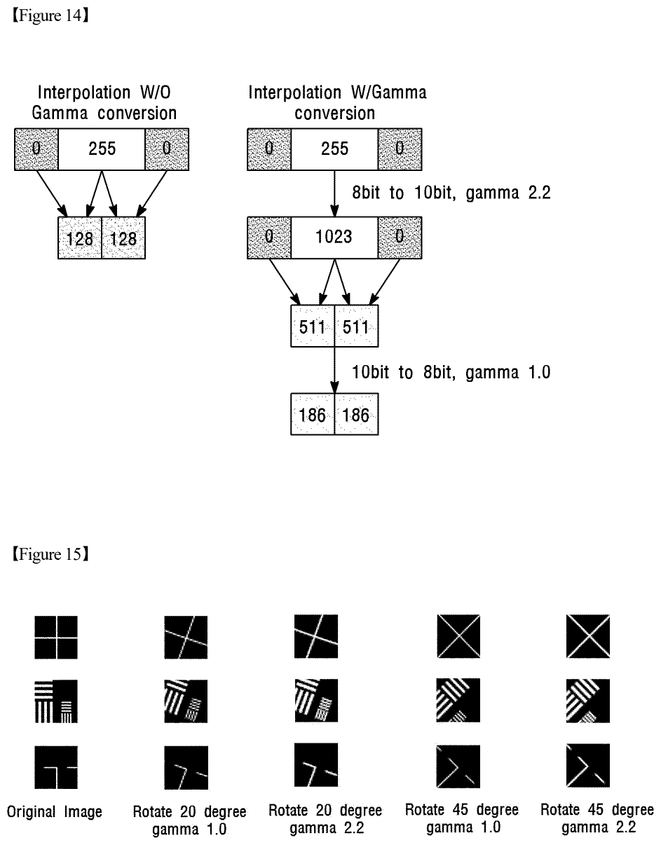

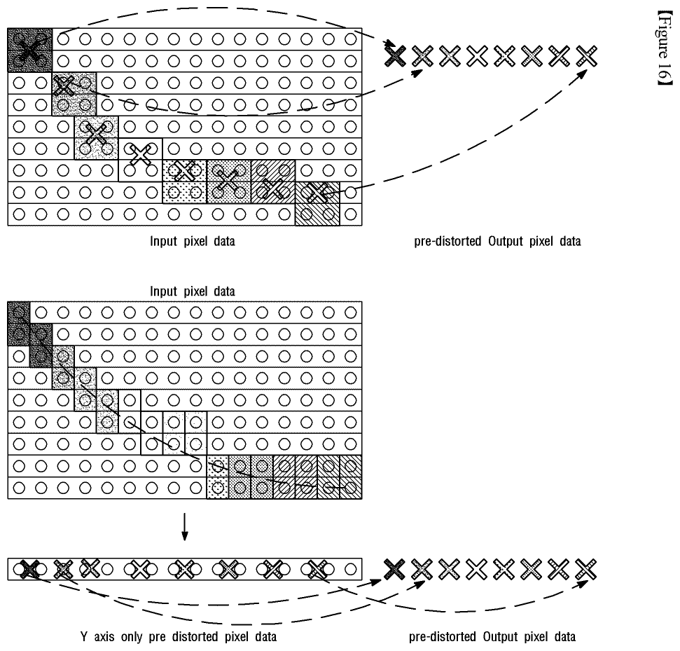

The buffer for Y-axis interpolation stores blocks required for Y-axis interpolation operation. The depacketizer extracts only pixel information required for Y-axis and X-axis interpolation calculations from image data stored in block units. The gamma 2.2 conversion unit and the gamma 1.0 conversion unit are configured to convert the brightness of pixel data, which will be specifically described with reference to FIGS. 14 and 15 below. The Y-axis interpolation unit performs Y-axis interpolation based on the position information of the pixel generated by the backward mapper FSM 1512 and the Y-axis LUT generated by the backward LUT generation unit 1511. The buffer for X-axis interpolation stores blocks required for X-axis interpolation operation. The X-axis interpolation unit performs X-axis interpolation based on the position information of the pixel generated by the backward mapper FSM 1512 and the X-axis LUT generated by the backward LUT generation unit 1511.

The display device according to the present invention has a backward LUT generation unit that generates different X-axis LUTs and Y-axis LUTs according to the type of image distortion. In addition, the backward LUT generation unit generates a distorted screen based on the generated X-axis LUTs, thereby enabling correction of screen distortion.

FIGS. 14 to 16 are views for explaining the operation of the gamma conversion section of the data pipeline. FIG. 14 illustrates the pixel calculation method of the data pipeline, and on the left is a view showing interpolation in the case of no gamma conversion. On the right of FIG. 14 is a view showing interpolation in the case of gamma conversion.

A pixel represents brightness of a given location, and the backward mapper is a device that represents a pixel corresponding to an arbitrary location, so brightness calculation is essential. The pixel data is not proportional to the brightness of the system, which is gamma 1.0. Therefore, the pixel data is converted to the gamma curve of the system's final display, interpolated, and then restored to gamma 1.0 to be transmitted to the panel.

FIG. 15 is a view illustrating result images according to gamma conversion. From the left, FIG. 15 illustrates an original image, a 20-degree rotation/gamma 1.0 conversion image, a 20-degree rotation/gamma 2.2 conversion image, a 45-degree rotation/gamma 1.0 conversion image, and a 45-degree rotation/gamma 2/2 conversion image.

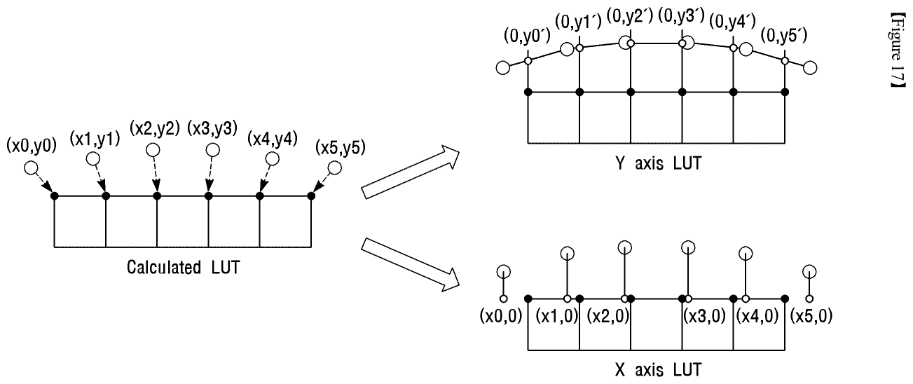

FIG. 16 is a view for explaining a two-step interpolation process in the data pipeline. General backward mapping requires four pixel values near the referenced location. Since data is stored in block units in the frame buffer, 1 to 4 blocks may be required depending on the boundary conditions. When interpolation is performed only for the Y axis, the referenced pixels are two nearby pixels, so 1 to 2 blocks may be required. In other words, there is an advantage that the memory bandwidth required for the frame buffer may be reduced by half.

Again, the X-axis LUT and Y-axis LUT generated by the backward LUT generation unit 1511 will be described. The values generated by the backward LUT generation unit 1511 have information on the positions of X and Y to be referenced. For two-step interpolation, the LUT is required to be separated into the Y-axis LUT and the X-axis LUT.

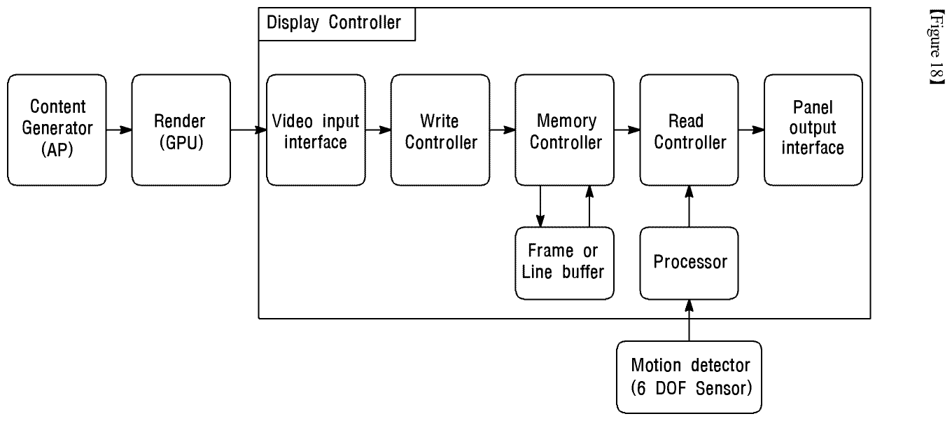

FIG. 17 is a schematic view showing the method of generating X-axis and Y-axis LUTs. The Y-axis LUT requires only the Y change amount required for Y-axis interpolation, which may be calculated by linear interpolation of two calculated nearby reference Y values. In this case, the X-axis LUT may use the X value of the calculated reference value as it is.

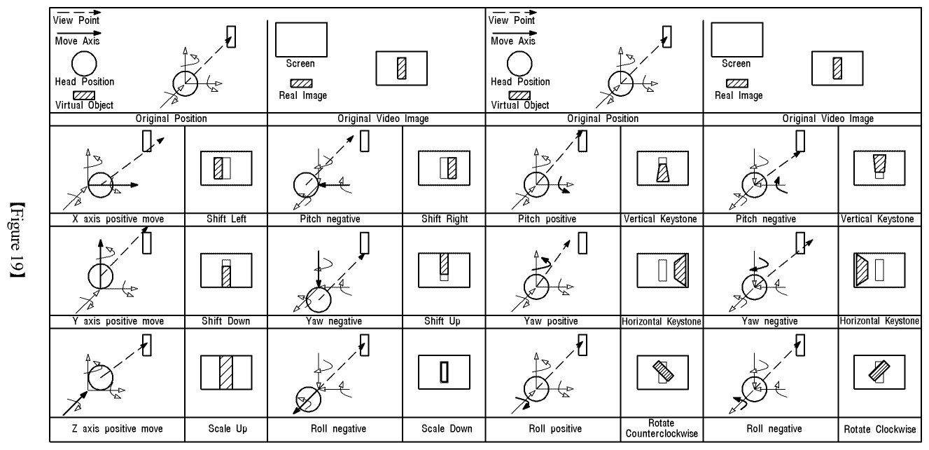

FIG. 18 is a block diagram of a system using a backward mapper according to the present invention. The backward mapper according to the present invention is mounted on an HMD and outputs an image corresponding to a user's head motion. That is, the backward mapper receives Yaw, Pitch, Roll, X, Y, and Z information and generates a necessary image through a combination of keystone, rotate, scale up-down, and shift x, y. Also, it is possible to respond to the user's head motion without separate rendering, including pre-stored optical information.

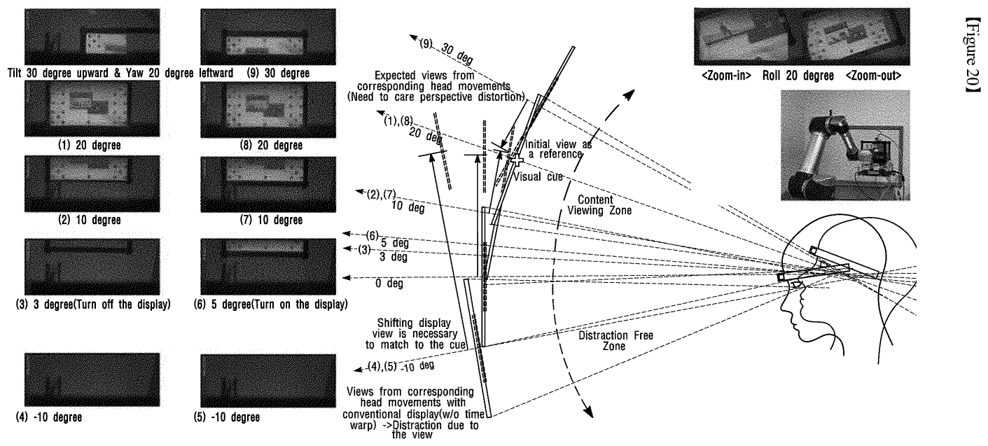

FIG. 19 is a view illustrating the types of image processing that must be performed in response to Yaw, Pitch, Roll, X, Y, and Z movements according to the user's head motion in the system illustrated in FIG. 18. According to the present invention, the amount of calculation required for image processing as shown in FIG. 19 is drastically reduced, thereby enabling implementation of a display device that is highly advantageous in terms of processing speed and power consumption.

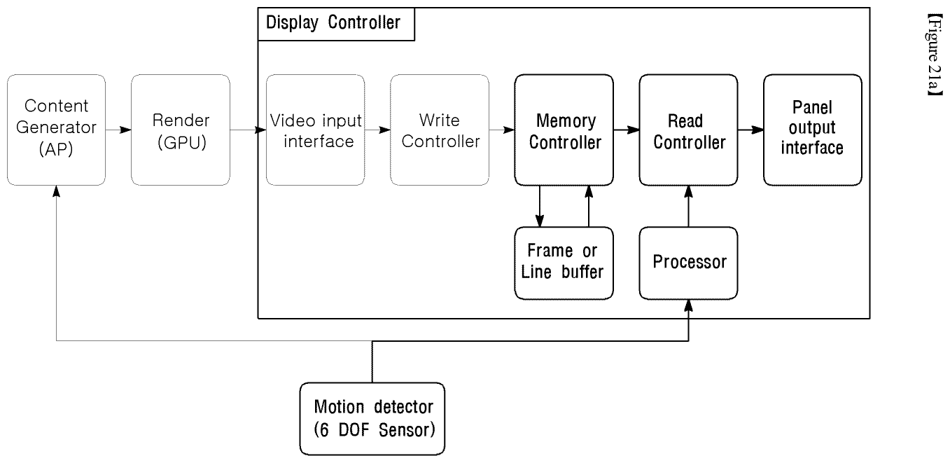

FIG. 20 is a view for explaining an effect of the display according to the present invention. In order to verify the effect of the present invention, digital IP is designed and integrated as RTL (Register Transfer Level) in FPGA. The 32-bit RISC-V processor core is selected to provide sufficient processing power with low power consumption for software algorithms and peripheral device control. The Xilinx Vertex-7 Ultrascale+evaluation board is used for the design of the display controller, and the display itself used a 0.55-inch FHD (Full High Definition) resolution FSC-type LCoS display panel and a birdbath type optic. The optic is designed for a 45-degree diagonal FOV (Field of View), and the operation result is evaluated by displaying a visual cue in a rectangular shape 0.5 m away from the sensor of a high-speed camera. The focal length of the camera lens is 18 mm, which is very similar to the focal length of the human eye, which is 17 mm.

A daughter board is designed to accommodate 3840×1080 60 Hz video for binocular systems (FHD per eye) via DisplayPort over USB-C for video input. Two data converter ICs split the input image and change the video interface for FPGA use. The display controller may be controlled via an external 8051 MCU (Micro Controller Unit) via USB or JTAG (Joint Test Action Group) interface.

To obtain head motion data, the controller is interfaced with a 6-DOF MPU-6050 MEMS (Micro Electro-Mechanical System) sensor that integrates an accelerometer and a gyroscope. This sensor provides sensor fusion processing and converts raw sensor data into quaternions. A processor embedded in the display controller reads the converted data periodically (100 Hz for evaluation) with interrupts generated from the sensor, calculates the Euler angles (yaw, pitch, roll) of the sensor, and applies Asynchronous Time Warp (ATW).

To analyze the applied ATW and dynamic morphing, a high-speed camera supporting global shutter is used to remove artifacts due to the rolling shutter effect. A capture frequency of 60 Hz is used to mimic human perception, and faster capture frequencies up to 1 kHz is also applied for further analysis. A 6-DoF industrial multi-joint robot arm is utilized to mimic human head motion for high repeatability.

The display controller designed in the FPGA drives the connected FSC LCOS display panel with embedded ATW function for a distraction-free display system. The embedded processor operates at a frequency of 32 MHz and the display controller drives the panel at a field rate of 218 Hz. Although the utilization of LUT, Block RAM, and Embedded SRAM-like memory (URAM) is not high at less than 10%, 6%, and 7%, respectively, this FPGA version has some limitations for timing optimization in mixed usage. The signal IP ASIC (Application-Specific Integrated Circuit) version, such as the Serializer De-serializer (SERDES), may run the processor and panel driver at up to 200 MHz and 360 Hz or more, respectively.

It utilizes CORDIC (Coordinate Rotation Digital Computer) for dynamic LUT generation and supports +/−1 radian for each rotation for view changes. The rotation angle resolution is 1/4096 radian, or approximately 0.014 degrees. This value is less than 1 arcmin, so it may be controlled in units of 1 pixel on most displays.

The logic complexity of a single backward mapper is about 586KGE (Kilo Gate Equivalent), and every block buffer in the mapper consumes 724KGE based on the synthetic reporter. The previous work was 720KGE for logic and 3830KGE for block buffer. The designed LUT controller supports grid sizes of 32×32 or 64×64. This means that the backward LUT controller updates the LUT every 32 or 64 lines. The LUT for optical correction requires about 25 kB per mapper to support FHD. The logic and memory size may be significantly reduced while adding new features, providing a wider correction range, and improving the image quality.

The MPU-6050 sensor generates 42-byte data chunks using a digital motion processing (DMP) mode and the data is available in the FIFO at the configured data output rate of 100 Hz. The processor checks the FIFO availability and reads the data chunks whenever the sensor interrupts the processor. It took 1.76 ms to acquire the sensor data over a 400 kHz I2C interface including some processing overhead. It took 0.79 ms to compute the Euler angles from the data and properly control the hardware IP for dynamic view changes. Each color field image reflects the most recent motion data. The yaw, pitch and roll angles are adjusted to morph the input image stored in the frame buffer memory, and then the lighting timing is properly controlled to transmit the morphed image to the panel.

The summarized results are as shown in FIG. 20. The view of the virtual screen is constantly changing according to the user's gaze, that is, the rotation of the head, giving a fixed feeling. The center of the optical tends to create the best vision while minimizing distortion, so that the content on the screen may be explored with the best image quality.

A bright screen often obscures the real world, as in (1) and (8) of FIG. 20. However, the display according to the present invention may avoid such obscuration by providing a content viewing area that may be configured differently from conventional information displays. The user may easily register the viewing area at a desired location. FIG. 20 shows an example of a scenario in which the center of the viewing area is 20° upward. The user may divide the viewing area with a slight hysteresis and the area without distraction by setting boundary conditions for pitch and yaw rotations. In this case, it is assumed that 5° is off and 7° is on. Since the optical device used provides a vertical FOV of approximately 22°, once the gaze, i.e., head movement, moves less than 3° (=20−(22−5)) or more than 37° (=20+(22−5)), the display automatically turns off when magnification is not applied. The display may turn back on when the line of sight is beyond 5° (=20−(22−7)) or 35° (=20+(22−7)) from an unobstructed area. This behavior aims to achieve an effect of significantly reducing power consumption while reflecting the user's intention more naturally.

Motion To Photon (MTP) Latency is the time it takes for the user's position movement or head rotation to be reflected on the display, and is an important performance indicator for AR, VR (Virtual Reality), and MR (Mixed Reality) devices. The best and worst MTP latency for the FPGA configuration are 6.71 ms and 16.71 ms, respectively. The average latency is expected to be 11.71 ms, which is relatively small compared to existing VR devices, and there is a high possibility that the latency may be reduced in the ASIC version.

Although lightweight wearable AR glasses are most desirable, the complexity of AR systems makes the AR glasses difficult to implement. The present invention provides a low-cost solution between high-end AR devices and low-cost head-mounted displays. The proposed system may improve user experience with a less complex system than AP/GPU-centric designs. It may also support sub-pixelated displays as well as FSC type displays. Experimental results for the present invention confirm feasibility thereof. The designed display controller includes special hardware that dynamically morphs the input video on the fly to provide seamless screen transitions according to the user's head movements. An embedded processor and peripherals for the IMU sensor handle head motion tracking and ATW operations. The present invention may be used in full-featured AR/MR systems to support 6-DOF morphing with ATW while offloading compute and memory intensive image transformation tasks from the host processor.

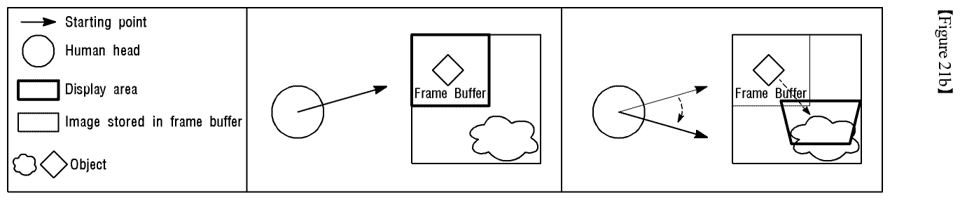

FIGS. 21a and 21b are views showing application examples of the present invention. FIGS. 21a and 21b are views for explaining the operation when the present invention is applied to a static image. In the case of content such as documents or books other than images or fixed images (e.g., icons, etc.), only the currently required screen may be recorded in the frame buffer. Thereafter, the recorded screen is output continuously, but the screen is output according to the movement. In other words, the frame buffer may be updated using an AP, GPU, etc. only when there is a change in the content.

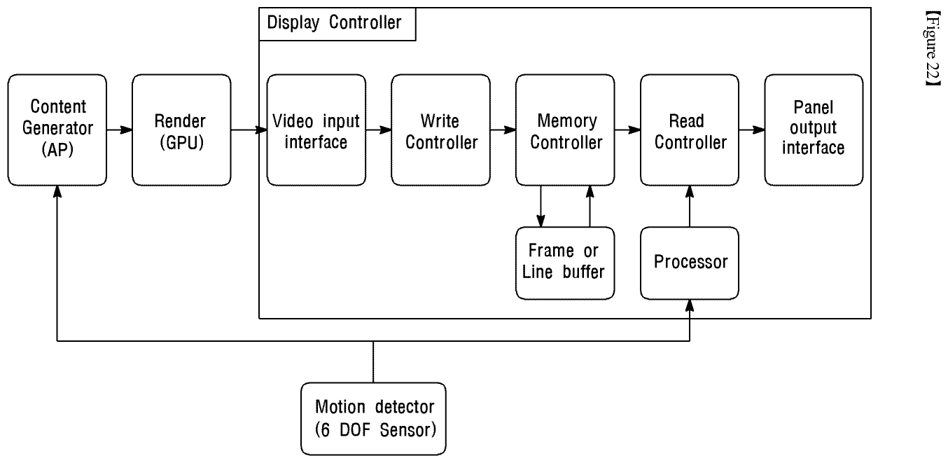

FIG. 22 is a view showing another application example of the present invention. When performing image processing on an AP or GPU, \textcircled{1} when the rendering speed of the AP or GPU is slower than the frame rate, \textcircled{2}; when the output frame rate is faster than the input frame rate due to frame rate conversion, \textcircled{3}; when frame rate conversion occurs due to display of FSC time, ATW (Asynchronous Time Warp) may be used.

Meanwhile, the screen distortion correction method according to the present invention includes generating an X-axis LUT (Look-Up Table) and a Y-axis LUT for generating a distorted reflection image (LUT generation step), generating position information of each pixel based on the X-axis LUT and the Y-axis LUT (position information generation step), performing Y-axis interpolation using the position information of the pixel and the Y-axis LUT for data read from a frame/line buffer (Y-axis interpolation performance step), performing X-axis interpolation using the position information of the pixel and the X-axis LUT for data read from the frame/line buffer (X-axis interpolation performance step), and outputting a distorted reflection image in which the Y-axis interpolation and the X-axis interpolation are performed (distorted reflection image output step). Here, the subject of the screen distortion correction method according to the present invention has been described in detail above, and a repeated description thereof will be avoided.

Here, depacketizing of extracting only pixel information required for the Y-axis interpolation and X-axis interpolation from data stored in block units may be further included. Furthermore, converting the extracted pixel information into a gamma curve of the final display may be further included.

Here, the LUT generation step generates each of the Y-axis LUT and the X-axis LUT based on at least one of a yaw value, a pitch value, a roll value, a rotation axis, and a field of view (FOV) according to user movement when the image distortion is keystone distortion or rotation distortion. In addition, when the image distortion is scaler or shift distortion, each of the Y-axis LUT and the X-axis LUT is generated based on at least one of an X-value change amount, a Y-value change amount, and a Z-value change amount according to user movement.

The method for correcting screen distortion according to the present invention may be implemented in the form of program commands that may be performed through various computer units and recorded on a computer-readable medium. The computer-readable recording medium may include program commands, data files, data structures, etc., either singly or in combination. The program commands recorded on the medium may be those specially designed and configured for the present invention or may be those known to and usable by those skilled in the art of computer software. Examples of computer-readable recording media include magnetic media such as hard disks, floppy disks, and magnetic tapes, optical media such as CD-ROMs and DVDs, magneto-optical media such as floptical disks, and hardware devices specifically configured to store and execute program instructions, such as ROMs, RAMs, and flash memories. Examples of program instructions include not only machine language codes generated by a compiler, but also high-level language codes that may be executed by a computer using an interpreter, etc. The above-mentioned hardware devices may be configured to operate as one or more software modules to perform the operations of the present invention, and vice versa.

In addition, although the above description has been made with reference to examples, these are merely examples and do not limit the present invention, and those with ordinary knowledge in the field to which the present invention pertains will recognize that various modifications and applications not exemplified above are possible without departing from the essential characteristics of the present invention. For example, each component specifically shown in the examples may be modified and implemented. And the differences related to such modifications and applications should be interpreted as being included in the scope of the present invention defined in the appended claims.

1. A display device comprising:
an input unit for configured to receive image data;
a recording unit configured to process and record the image data;
a storage unit configured to store the recorded image data in a frame/line buffer;
a reading unit configured to read the stored image data; and
an output unit configured to output the read image data,
wherein the reading unit comprises a backward mapper configured to generate distorted reflection image data using different two LUTs.

2. The display device of claim 1, wherein the two LUTs comprise an X-axis look-up table (LUT) for X-axis interpolation and a Y-axis LUT for Y-axis interpolation.

3. The display device of claim 2, wherein the backward mapper comprises:
a backward LUT generation unit configured to generate the X-axis LUT and the Y-axis LUT;
a data pipeline configured to process image data input from the frame/line buffer; and
a backward mapper FSM configured to generate position information of each pixel based on the X-axis LUT and the Y-axis LUT and control the data pipeline.

4. The display device of claim 3, wherein the data pipeline comprises:
a Y-axis interpolation unit configured to perform the Y-axis interpolation based on position information of pixels generated from the backward mapper FSM and the Y-axis LUT; and
an X-axis interpolation unit configured to perform the X-axis interpolation based on position information of pixels generated from the backward mapper FSM and the X-axis LUT.

5. The display device of claim 3, wherein the data pipeline further comprises:
a Y-axis interpolation buffer configured to store blocks required for the Y-axis interpolation calculation;
an X-axis interpolation buffer configured to store blocks required for the X-axis interpolation calculation;
a depacketizer configured to extract only pixel information required for the Y-axis and X-axis interpolation calculations from image data stored in block units; and
one or more gamma converters configured to convert the extracted pixel information into a gamma curve of a final display.

6. The display device of claim 3, wherein the backward LUT generation unit generates different X-axis LUTs and Y-axis LUTs depending on the type of image distortion.

7. The display device of claim 6, wherein when the image distortion is keystone distortion or rotation distortion, the backward LUT generation unit generates each of the Y-axis LUT and the X-axis LUT based on at least one of a yaw value, a pitch value, a roll value, a rotation axis, and a field of view (FOV) according to user's movement.

8. The display device of claim 6, wherein when the image distortion is a scaler or shift distortion, the backward LUT generation unit generates each of the Y-axis LUT and the X-axis LUT based on at least one of an X-value change amount, a Y-value change amount, and a Z-value change amount transmitted according to the user's movement.

9. A method for correcting screen distortion, comprising:
generating an X-axis LUT and a Y-axis LUT for generating a distorted reflection image;
generating position information of each pixel based on the X-axis LUT and the Y-axis LUT;
performing Y-axis interpolation using the pixel position information and the Y-axis LUT for data read from a frame/line buffer;
performing X-axis interpolation using the pixel position information and the X-axis LUT for data read from the frame/line buffer; and
outputting a distorted reflection image in which the Y-axis interpolation and the X-axis interpolation are performed.

10. The method of claim 9, further comprising depacketizing to extract only the pixel information required for Y-axis interpolation and X-axis interpolation from data stored in block units.

11. The method of claim 10, further comprisingconverting the extracted pixel information into a gamma curve of a final display.

12. The method of claim 9, wherein the generating of the X-axis LUT and the Y-axis LUT generates each of the Y-axis LUT and the X-axis LUT based on at least one of a yaw value, a pitch value, a roll value, a rotation axis, and a field of view (FOV) according to user's movement when the image distortion is keystone distortion or rotation distortion.

13. The method of claim 9, wherein the generating of the X-axis LUT and the Y-axis LUT generates each of the Y-axis LUT and the X-axis LUT based on at least one of an X-value change amount, a Y-value change amount, and a Z-value change amount according to the user's movement when the image distortion is a scaler or shift distortion.
